(19) United States
(12) Patent Application Publication
(10) Pub. No.: US 2025/0372959 A1
(43) Pub. Date: Dec. 4, 2025

(54) SPARK PLUG

(71) Applicant: Niterra Co., Ltd., Nagoya-shi (JP)

(72) Inventors: Kaito NAKAMURA, Nagoya-shi (JP); Kengo HATTORI, Nagoya-shi (JP); Hiroaki IZAWA, Nagoya-shi (JP); Mayu FUJISAWA, Nagoya-shi (JP)

(73) Assignee: Niterra Co., Ltd., Nagoya-shi (JP)

(21) Appl. No.: 19/217,530

(22) Filed: May 23, 2025

(30) Foreign Application Priority Data
May 28, 2024 (JP) 2024-086542

(51) Int. Cl. H01T 13/32; H01T 13/34

(52) U.S. Cl. CPC H01T 13/32; H01T 13/34

(57) ABSTRACT

A spark plug includes an insulator that has an axial hole extending along an axial line; a center electrode that is disposed in the axial hole; a metal shell that is disposed at an outer periphery of the insulator; and a ground electrode that is connected to the metal shell. At least one of the center electrode and the ground electrode has a tip whose main component is Ru, and a porosity of the tip is greater than or equal to 0.1 ppm and less than or equal to 100000 ppm.

### FIELD OF THE INVENTION

The present invention relates to a spark plug that has a tip containing Ru.

### BACKGROUND OF THE INVENTION

A related art in which at least one of a center electrode and a ground electrode has a tip made simply of Ru or made of an Ru alloy is disclosed in Japanese Unexamined Patent Application Publication No. 5-54955.

Since a tip whose main component is Ru generally lacks ductility, the tip may crack due to vibration of, for example, an engine.

### SUMMARY OF THE INVENTION

The present invention has been made to solve the above-referenced problem, and it is an object of the present invention to provide a spark plug that is capable of reducing cracking of a tip.

To this end, according to a first aspect, there is provided a spark plug including an insulator that has an axial hole extending along an axial line; a center electrode that is disposed in the axial hole; a metal shell that is disposed at an outer periphery of the insulator; and a ground electrode that is connected to the metal shell, in which at least one of the center electrode and the ground electrode has a tip whose main component is Ru, and in which a porosity of the tip is greater than or equal to 0.1 ppm and less than or equal to 100000 ppm.

According to a second aspect based on the first aspect, an amount of hydrogen that is contained in the tip is greater than or equal to 0.1 ppm and less than or equal to 4 ppm.

According to a third aspect based on the first aspect or the second aspect, the tip contains Pt.

According to a fourth aspect based on the third aspect, a proportion of the Pt in the tip is greater than or equal to 0.1 mass % and less than or equal to 30 mass %.

According to a fifth aspect based on any one of the first aspect to the fourth aspect, a Vickers hardness of the tip is greater than or equal to 190 HV.

According to the present invention, by causing the porosity of the tip to be greater than or equal to 0.1 ppm and less than or equal to 100000 ppm, stress is reduced by pores and cracking can be reduced.

### BRIEF DESCRIPTION OF THE DRAWINGS

FIG. 1 is a sectional view of one side of a spark plug of an embodiment.

FIG. 2 is a sectional view of a portion where a center electrode and a ground electrode of the spark plug face each other.

### DETAILED DESCRIPTION OF THE INVENTION

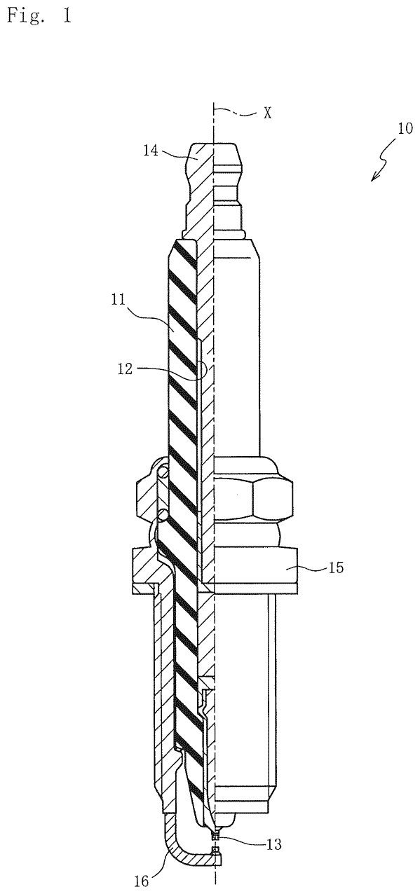

A preferred embodiment of the present invention is described below with reference to the attached drawings. FIG. 1 is a sectional view of one side of a spark plug 10 of an embodiment with an axial line X being a boundary. In FIG. 1, a lower side in a sheet plane is a front end side of the spark plug 10, and an upper side in the sheet plane is a rear end side of the spark plug 10.

As shown in FIG. 1, the spark plug 10 includes an insulator 11, a center electrode 13, a metal shell 15, and a ground electrode 16. The insulator 11 is a substantially cylindrical member that is made of ceramic such as alumina having excellent mechanical characteristics and excellent insulating properties under high temperature. The insulator 11 has an axial hole 12 that extends therethrough along the axial line X. The center electrode 13 is a rod electrode that is disposed in the axial hole 12 along the axial line X.

A metal terminal 14 is a rod member to which an ignition system (not shown) is connected, and its front end side is disposed in the axial hole 12 of the insulator 11. The metal terminal 14 is electrically connected to the center electrode 13 in the axial hole 12.

The metal shell 15 is a substantially cylindrical metal member that is fixed to a threaded hole (not shown) of an internal combustion engine. The metal shell 15 is made of a conductive metal material (such as low-carbon steel). The metal shell 15 is fixed to an outer periphery of the insulator 11. The ground electrode 16 is connected to the metal shell 15.

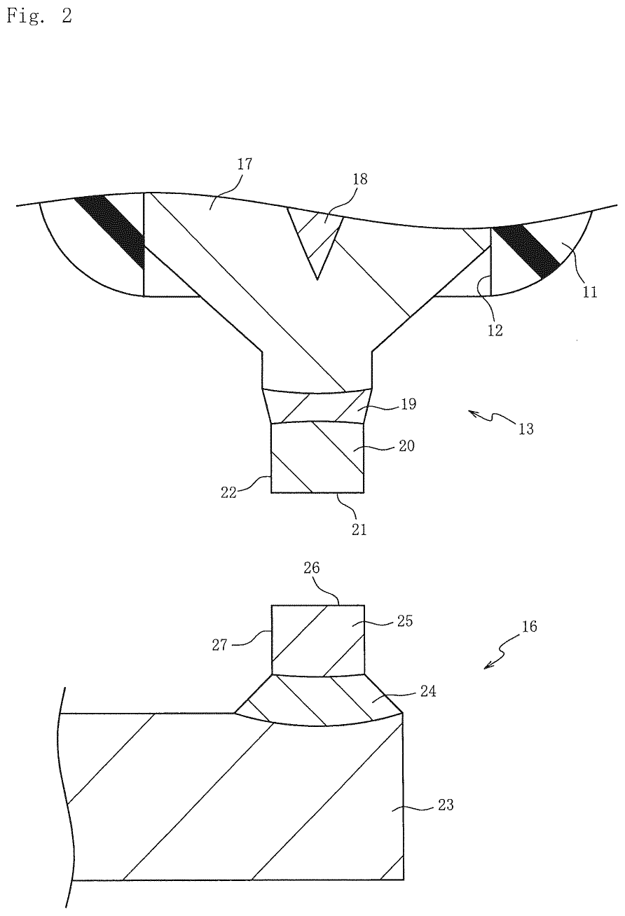

FIG. 2 is a sectional view of a portion where the center electrode 13 and the ground electrode 16 of the spark plug 10 face each other. The center electrode 13 includes a base member 17 and a tip 20 that is provided at a front end of the base member 17.

A core member 18 having excellent thermal conductivity is embedded in the base member 17. The material of the base member 17 is, for example, Ni or an alloy whose main component is Ni, and the material of the core member 18 is, for example, Cu or an alloy whose main component is Cu. The core member 18 can be omitted.

The tip 20 is joined to the base member 17 by a fusion portion 19. The fusion portion 19 is where the tip 20 and the base member 17 are melted. The fusion portion 19 is formed by, for example, laser beam welding or resistance welding, or diffusion joining. The tip 20 has a front end surface 21 in a thickness direction of the tip 20, and a side surface 22 that is connected to the front end surface 21.

The ground electrode 16 includes a base member 23 that is connected to the metal shell 15, and a tip 25 that is provided at the base member 23. A core member (not shown) having excellent thermal conductivity is embedded in the base member 23. The material of the base member 23 is an alloy whose main component is Ni, and the material of the core member is Cu or an alloy whose main component is Cu. The core member can be omitted. An intermediate member that protrudes toward the center electrode 13 may be provided at the base member 23, and the tip 25 may be joined to the intermediate member. The intermediate member is part of the base member 23.

The tip 25 is joined to the base member 23 by a fusion portion 24. The fusion portion 24 is where the tip 25 and the base member 23 are melted. The fusion portion 24 is formed by, for example, laser beam welding or resistance welding, or diffusion joining. The tip 25 has a front end surface 26 in a thickness direction of the tip 25, and a side surface 27 that is connected to the front end surface 26. In the embodiment, the front end surface 21 of the tip 20 of the center electrode 13 and the front end surface 26 of the tip 25 of the ground electrode 16 face each other, and a spark gap is provided between the front end surface 21 and the front end surface 26.

The main component of at least one of the tips 20 and 25 is Ru. “The main component is Ru” means that, of the contents of the elements that make up the tips 20 and 25, the content of Ru is the largest. The content of Ru is preferably greater than or equal to 50 mass % and is more preferably greater than or equal to 60 mass % or greater than or equal to 70 mass % with respect to the amount of all components that make up the tips 20 and 25.

When the main component of the tip 20 of the center electrode 13 is Ru or when the main component of the tip 25 of the ground electrode 16 is Ru, the element or the elements other than Ru that make up the tips 20 and 25 are, for example, one or more types of elements selected from Rh, Pd, Os, Ir, Pt, Ta, W, Mo, Nb, Re, Cr, Mn, Fe, Co, Ni, V, Ti, Zr, Hf, Al, and Sc.

When the main component of the tip 20 of the center electrode 13 is Ru, the ground electrode 16 is one that has the tip 25 whose main component is Ru, one that has the tip 25 whose main component is selected from one or more types of platinum elements (Rh, Pd, Os, Ir, and Pt) other than Ru, or one in which the fusion portion 24 and the tip 25 are not provided at the base member 23.

When the main component of the tip 25 of the ground electrode 16 is Ru, the center electrode 13 is one that has the tip 20 whose main component is Ru, one that has the tip 20 whose main component is selected from one or more types of platinum elements (Rh, Pd, Os, Ir, and Pt) other than Ru, or one in which the fusion portion 19 and the tip 20 are not provided at the base member 17.

The spark plug 10 is formed by, for example, the following method. First, the center electrode 13 is inserted into the axial hole 12 of the insulator 11. Next, after the metal terminal 14 has been inserted into the axial hole 12 and continuity between the metal terminal 14 and the center electrode 13 has been ensured, the metal shell 15 to which the ground electrode 16 has been previously connected is assembled to the outer periphery of the insulator 11. The ground electrode 16 is bent and a spark gap is formed between the center electrode 13 and the ground electrode 16 to obtain the spark plug 10.

The tips 20 and 25 whose main component is Ru are formed by, for example, sintering a molded product of metal powder containing Ru (powder metallurgy process), performing punching on a metal plate containing Ru, or cutting a metal wire rod containing Ru. The shape of each of the tips 20 and 25 is not limited and is, for example, a disc shape, a truncated conical shape, an elliptical cylindrical shape, or a polygonal prism shape such as a triangular prism shape or a square prism shape.

When the main component of the tip 20 of the center electrode 13 is Ru, the porosity of the tip 20 is greater than or equal to 0.1 ppm and less than or equal to 100000 ppm. It is possible to reduce stress by pores of the tip 20 and to reduce cracking of the tip 20. When the porosity is low, stress tends to be less likely to be reduced, and when the porosity is high, the mechanical strength of the tip 20 tends to be reduced.

The porosity of the tip 20 is measured by the Archimedes method with regard to a portion obtained by cutting the tip 20 and separating the fusion portion 19. When the tip 20 is formed by the powder metallurgy process, the porosity of the tip 20 can be set by adjusting the particle size distribution or the sintering temperature of metal powder. When the tip 20 is formed by performing punching on a metal plate or by cutting a wire rod, the porosity can be set by adjusting processing conditions, such as casting conditions or rolling conditions of the plate or the wire rod.

The amount of hydrogen that is contained in the tip 20 is preferably greater than or equal to 0.1 ppm and less than or equal to 4 ppm. The hydrogen that is contained in the tip 20 is discharged at a temperature at which the spark plug 10 is used, and a gap where the hydrogen has come out is formed in the tip 20. This is because since the gap reduces stress, cracking of the tip 20 can be further reduced. When the amount of hydrogen is small, stress tends to be less likely to be reduced, and when the amount of hydrogen is large, metal bond defects of the tip 20 are increased and the mechanical strength of the tip 20 tends to be reduced.

The amount of hydrogen that is contained in the tip 20 is measured by using an atmospheric pressure ionization mass spectrometer with regard to a portion obtained by cutting the tip 20 and separating the fusion portion 19. The temperature of the tip 20 is increased at a speed of 10° C./min from room temperature to 900° C. in an argon atmosphere, and the amount of discharged hydrogen is measured.

When the tip 20 is formed by the powder metallurgy process, the amount of hydrogen that is contained in the tip 20 can be set by adjusting the hydrogen concentration of an atmosphere at the time of, for example, sintering or annealing. When the tip 20 is formed by performing punching on a metal plate or by cutting a wire rod, the amount of hydrogen of the tip 20 can be set by adjusting the hydrogen concentration of an atmosphere at the time of producing the plate or the wire rod and by adjusting the pressure at the time of sintering.

When the tip 20 contains Pt, since Pt exhibits high affinity for hydrogen and the hydrogen is taken in by a Pt crystal lattice, it is advantageous in increasing the amount of hydrogen that is contained in the tip 20. The proportion of Pt in the tip 20 is preferably greater than or equal to 0.1 mass % and less than or equal to 30 mass %. This is to ensure the mechanical strength of the tip 20.

The Vickers hardness of the tip 20 is preferably greater than or equal to 190 HV. This is to ensure the mechanical strength of the tip 20. The Vickers hardness of the tip 20 is measured by pushing an indenter into a cross section of the tip 20 or the front end surface 21. The Vickers hardness can be adjusted by, for example, temperature or pressure conditions at the time of processing or sintering the tip 20.

When the main component of the tip 25 of the ground electrode 16 is Ru, the porosity, the amount of hydrogen, the proportion of Pt, or the Vickers hardness of the tip 25 is set in the same range as the porosity, the amount of hydrogen, the proportion of Pt, or the Vickers hardness of the tip 20 of the center electrode 13. This makes it possible to reduce cracking of the tip 25.

### EXAMPLES

Although the present invention will be described in more detail by way of examples, the present invention is not limited to the examples.

By a powder metallurgy process, a tester formed tips of Nos. 1 to 50 having different porosities and having columnar shapes whose diameters were 0.6 mm and whose heights were 0.5 mm. The tips of Nos. 1 to 8 were made of an Ru—Pt alloy containing 0.1 mass % of Pt with the remaining amount being that of Ru, the amount of hydrogen of each of these tips was 0.1 ppm to 0.2 ppm, and the Vickers hardness of each of these tips was 190 HV to 200 HV. The tips of Nos. 9 to 13 were made of an Ru—Pt alloy containing 0.1 mass % of Pt with the remaining amount being that of Ru, and the Vickers hardness of each of these tips was 190 HV to 200 HV. The Vickers hardness of each of the tips of Nos. 14 to 44 was 190 HV to 200 HV.

The porosity of each tip was set by adjusting the particle size distribution and the sintering temperature of metal powder. The amount of hydrogen of each tip was set by the hydrogen gas amount at the time of sintering. The Vickers hardness of each tip was set by the pressure at the time of sintering. The tester, after having formed center electrodes in which the tips were joined to respective base members, produced spark plugs similar to that of the embodiment above, and formed samples of the spark plugs of Nos. 1 to 50 in each of which a spark gap was provided between a ground electrode and a front end surface of the tip of the center electrode.

The tester separated the tips from the samples, measured the porosities of the tips by the Archimedes method (the number of samples was ten), and measured the amounts of hydrogen contained in the tips by using an atmospheric pressure ionization mass spectrometer (the number of samples was ten). Further, an indenter was pushed into five locations of cross sections of the tips, and the Vickers hardness of each tip was measured (the number of samples was five). The average of the measured values was made a typical value of the porosity, the amount of hydrogen, and the Vickers hardness of each sample.

The tester performed the following test, that is, after having attached, of the samples of Nos. 1 to 50, each of the samples whose tip was not separated to an engine (type L13A) and after having operated the engine for one minute at an engine revolution of 5000 rpm, the tester immediately operated the engine for one minute at an engine revolution of 800 rpm, alternately repeated the operations, and continuously operated the engine for 100 hours. After the test, cross sections parallel to axial lines including centers of the front end surfaces of the respective tips were formed and the tips were observed for any cracks by using a metallurgical microscope. When there is a crack in a tip, since the crack extends in a direction of extension of the front end surface of the tip, the length of the crack extending in the direction of extension of the front end surface is divided by the length of the front end surface to calculate the proportion of the crack.

Any sample in which a crack was not observed in the tip had a determination result A, and any sample in which the proportion of the crack was greater than 0% and less than 30% had a determination result B. Any sample in which the proportion of the crack was greater than or equal to 30% and less than 50% had a determination result C, any sample in which the proportion of the crack was greater than or equal to 50% and less than 90% had a determination result D, and any sample in which the proportion of the crack was greater than or equal to 90% had a determination result E. The results are given in Tables 1 to 4.

TABLE 1

| | porosity | determination |
|---|---|---|
| No. | (ppm) | result |
| 1 | 0.09 | E |
| 2 | 0.10 | C |
| 3 | 1.0 | C |
| 4 | 10 | C |
| 5 | 100 | C |
| 6 | 1000 | B |
| 7 | 10000 | B |
| 8 | 100001 | E |

TABLE 2

| | | amount of | |
|---|---|---|---|
| | porosity | hydrogen | determination |
| No. | (ppm) | (ppm) | result |
| 9 | 176 | 0.09 | D |
| 10 | 221 | 0.1 | C |
| 11 | 154 | 2.0 | C |
| 12 | 163 | 4.0 | C |
| 13 | 198 | 4.1 | D |

TABLE 3

| | | amount of | proportion of | |
|---|---|---|---|---|
| | porosity | hydrogen | Pt | determination |
| No. | (ppm) | (ppm) | (wt %) | result |
| 14 | 5720 | 0.09 | 0.05 | D |
| 15 | 5517 | 0.05 | 35 | D |
| 16 | 4196 | 0.08 | 30 | C |
| 17 | 5990 | 0.09 | 1 | C |
| 18 | 5690 | 0.10 | 0.1 | B |
| 19 | 5961 | 0.10 | 35 | C |
| 20 | 5287 | 0.19 | 30 | B |
| 21 | 5467 | 1.00 | 1 | B |
| 22 | 5635 | 1.14 | 30 | B |
| 23 | 4439 | 1.40 | 20 | B |
| 24 | 5902 | 1.60 | 25 | B |
| 25 | 5937 | 1.90 | 10 | B |
| 26 | 5470 | 2.00 | 5 | B |
| 27 | 5632 | 2.10 | 15 | B |
| 28 | 5720 | 2.26 | 25 | B |
| 29 | 4669 | 2.30 | 5 | B |
| 30 | 5128 | 3.50 | 15 | B |
| 31 | 4559 | 3.90 | 1 | B |
| 32 | 5500 | 4.00 | 5 | B |
| 33 | 5680 | 4.00 | 15 | B |
| 34 | 5623 | 4.00 | 20 | B |
| 35 | 5411 | 4.00 | 35 | C |
| 36 | 5349 | 4.10 | 1 | C |
| 37 | 4070 | 4.10 | 30 | C |
| 38 | 5200 | 4.10 | 35 | D |
| 39 | 5416 | 4.45 | 25 | C |
| 40 | 5423 | 4.60 | 10 | C |
| 41 | 4033 | 5.30 | 20 | C |
| 42 | 5985 | 5.50 | 5 | C |
| 43 | 5995 | 7.50 | 15 | C |
| 44 | 4353 | 10.00 | 10 | C |

TABLE 4

| | | amount of | proportion of | | |
|---|---|---|---|---|---|
| | porosity | hydrogen | Pt | hardness | determination |
| No. | (ppm) | (ppm) | (wt %) | (HV) | result |
| 45 | 3025 | 0.09 | 0.05 | 150 | D |
| 46 | 3558 | 0.10 | 0.1 | 250 | A |
| 47 | 3980 | 2.00 | 5.0 | 380 | A |
| 48 | 3214 | 4.00 | 15.0 | 190 | A |
| 49 | 3502 | 4.10 | 30.0 | 400 | B |
| 50 | 3900 | 4.10 | 30.1 | 200 | C |

According to Table 1, Sample Nos. 2 to 7 in which the porosities of the tips were greater than or equal to 0.1 ppm and less than or equal to 100000 ppm each had a determination result B or C, whereas Sample No. 1 in which the porosity was less than 0.1 ppm and Sample No. 8 in which the porosity was greater than 100000 ppm each had a determination result E. Therefore, it has become clear that when the porosity of a tip is greater than or equal to 0.1 ppm and less than or equal to 100000 ppm, it is possible to reduce cracking of a tip.

According to Table 2, Sample Nos. 10 to 12 in which the amounts of hydrogen of the tips were greater than or equal to 0.1 ppm and less than or equal to 4.0 ppm each had a determination result C, whereas Sample No. 9 in which the amount of hydrogen was less than 0.1 ppm and Sample No. 13 in which the amount of hydrogen was greater than 4.0 ppm each had a determination result D. Therefore, it has become clear that when the amount of hydrogen contained in a tip is greater than or equal to 0.1 ppm and less than or equal to 4.0 ppm, it is possible to further reduce cracking of a tip.

According to Table 3, Sample Nos. 18 and 20 to 34 in which the porosities of the tips were from near 4000 ppm to near 6000 ppm and the amounts of hydrogen of the tips were greater than or equal to 0.1 ppm and less than or equal to 4.0 ppm each had a determination result B, whereas Sample Nos. 14 to 17 in which the amounts of hydrogen were less than 0.1 ppm and Sample Nos. 36 to 44 in which the amounts of hydrogen were greater than 4.0 ppm each had a determination result C or D. Therefore, it has become clear that when the amount of hydrogen contained in a tip is greater than or equal to 0.1 ppm and less than or equal to 4.0 ppm, it is possible to further reduce cracking of a tip.

According to Table 3, Sample Nos. 18 and 20 to 34 in which the amounts of hydrogen of the tips were greater than or equal to 0.1 ppm and less than or equal to 4.0 ppm and the proportions of Pt were greater than or equal to 0.1 mass % and less than or equal to 30 mass % each had a determination result B, whereas Sample Nos. 19 and 35 in which the amounts of hydrogen of the tips were greater than or equal to 0.1 ppm and less than or equal to 4.0 ppm and the proportions of Pt were greater than 30 mass % each had a determination result C. Therefore, it has become clear that when the proportion of Pt is greater than or equal to 0.1 mass % and less than or equal to 30 mass %, it is possible to further reduce cracking of a tip.

According to Table 4, Sample Nos. 46 to 48 in which the porosities of the tips were greater than or equal to 0.1 ppm and less than or equal to 100000 ppm, the amounts of hydrogen of the tips were greater than or equal to 0.1 ppm and less than or equal to 4.0 ppm, the proportions of Pt were greater than or equal to 0.1 mass % and less than or equal to 30 mass %, and the Vickers hardnesses were greater than or equal to 190 HV each had a determination result A, whereas the other samples each had a determination result B, C, or D.

Although the present invention has been described on the basis of an embodiment, the present invention is not limited in any way to the embodiment above, and it can be easily inferred that various improvements and modifications are possible within a scope that does not depart from the spirit of the present invention.

Although, in the embodiment, the ground electrode 16 has been described as being bent, the ground electrode 16 is not limited thereto. It is naturally possible to use a linear ground electrode 16 instead of the bent ground electrode 16. In this case, the front end side of the metal shell 15 is extended in an axial direction and the linear ground electrode 16 is joined to the metal shell 15. The number of ground electrodes 16 is also set as appropriate.

Although, in the embodiment, the center electrode 13 and the ground electrode 16 are described as being disposed such that a spark gap is formed in the direction of the axial line X between the ground electrode 16 and the front end surface 21 of the tip 20 of the center electrode 13, the arrangement is not necessarily limited thereto. The positional relationship between the center electrode 13 and the ground electrode 16 can be set as appropriate. As an example of another positional relationship between the center electrode 13 and the ground electrode 16, the ground electrode 16 and the side surface 22 of the tip 20 of the center electrode 13 are caused to face each other in a direction perpendicular to the axial line X such that a spark gap is formed in the direction perpendicular to the axial line X between the center electrode 13 and the ground electrode 16.

### DESCRIPTION OF REFERENCE NUMERALS

10 spark plug
11 insulator
12 axial hole
13 center electrode
15 metal shell
16 ground electrode
17 base member
20, 25 tip
X axial line

What is claimed is:

1. A spark plug comprising:
an insulator that has an axial hole extending along an axial line;
a center electrode that is disposed in the axial hole;
a metal shell that is disposed at an outer periphery of the insulator; and
a ground electrode that is connected to the metal shell,
wherein at least one of the center electrode and the ground electrode has a tip whose main component is Ru, and
wherein a porosity of the tip is greater than or equal to 0.1 ppm and less than or equal to 100000 ppm.

2. The spark plug according to claim 1, wherein an amount of hydrogen that is contained in the tip is greater than or equal to 0.1 ppm and less than or equal to 4 ppm.

3. The spark plug according to claim 1, wherein the tip contains Pt.

4. The spark plug according to claim 3, wherein a proportion of the Pt in the tip is greater than or equal to 0.1 mass % and less than or equal to 30 mass %.

5. The spark plug according to claim 1, wherein a Vickers hardness of the tip is greater than or equal to 190 HV.
